(19) United States
(12) Patent Application Publication
(10) Pub. No.: US 2014/0300062 A1
(43) Pub. Date: Oct. 9, 2014

(54) Seal Structure

(71) Applicant: HI-LEX CORPORATION, Takarazuka-shi, Hyogo (JP)

(72) Inventor: Kunimitsu Nakai, Hyogo (JP)

(21) Appl. No.: 14/355,180

(22) PCT Filed: Oct. 31, 2012
(86) PCT No.: PCT/JP2012/078085

§ 371 Date: Apr. 29, 2014

(30) Foreign Application Priority Data
Oct. 31, 2011 (JP) 2011-239127

(51) Int. Cl. F16J 15/10

(52) U.S. Cl. CPC F16J 15/104
USPC 277/616

(57) ABSTRACT

A seal structure which restrains deterioration in sealability when a location of a contact surface varies, and has reduced size. The seal structure includes a first panel, a second panel, and a grommet body. The first panel includes an aperture and a contact surface. The grommet body includes securing parts, a main body, an exterior edge, and first, and second seals. The first seal is made of an elastic material and extends from the exterior edge toward the contact surface to surround the main body and contact the contact surface. The second seal is made of an elastic material and extends from the exterior edge toward the contact surface to surround the first seal and contact the contact surface. An interval between the tips of the first and second seals is wider than an interval between the proximal ends of the first and second seals.

### TECHNICAL FIELD

The present invention relates to a seal structure provided to a panel having an aperture for inserting a cable therein.

### BACKGROUND ART

Conventionally, a cable is used to connect a shift lever arranged in a vehicle room and a transmission arranged outside the room. The cable transmits the operation which a driver input from the shift lever to the transmission. The cable is introduced from the inside to the outside of the room through an aperture formed on a panel partitioning the inside and the outside of the vehicle room. A technique is known in which, a seal structure is formed around the aperture to support the cable passing through the aperture and prevent intrusion of an object such as water, dust, and exhaust fume and noise from the outside into the inside of the room through the aperture.

For example, in Patent Literature 1, a support structure for a control cable of a transmission is disclosed. The support structure includes a grommet having an insertion hole in which the control cable is inserted and a retainer for attaching the grommet to a vehicle panel. When the grommet is attached to the vehicle panel by the retainer, the aperture formed on the vehicle panel is sealed by the grommet.

In this manner, a grommet is used as a component of a seal structure. Further, a grommet configured to form a seal between the vehicle panel is proposed. For example, a grommet described in Patent Literature 2 includes a small-sized tubular portion having an insertion hole in which a wire harness can be inserted, a flange portion protruding from the small-sized tubular portion, and a roughened portion formed on the surface of the flange portion facing the vehicle panel. When the grommet is attached to the vehicle panel, the roughened portion contacts the periphery of the aperture formed on the vehicle panel.

Further, a grommet described in Patent Literature 3 includes a grommet main body part having a disk-like base plate and radially outer and inner lips arranged in the inner circumference of the surface of the base plate. When the grommet is attached to the vehicle panel, the lip is pressed to the panel to provide waterproof.

### CITATION LIST

### Patent Literatures

Patent Literature 1: JP 9-240303 A
Patent Literature 2: JP 2000-289547 A
Patent Literature 3: JP 8-316658 A

### SUMMARY OF INVENTION

### Technical Problem

Regarding a seal structure in which a grommet is attached to an aperture of a panel unit having a first panel and a second panel arranged to face each other, in the manufacturing of the panel unit having different panels, that is, a panel to which the grommet is secured and a panel having a contact surface which the grommet contacts, the distance between the first and second panels may vary. When the location of the contact surface varies, sealability may be deteriorated in a conventional grommet structure.

For example, as for the grommet described in Patent Literature 2, when the distance between a flange portion of the grommet and the first panel is large in a state in which the grommet is secured to the second panel, an interval may be produced between the roughened portion formed on the flange portion and the contact surface of the first panel. Besides, regarding the grommet described in Patent Literature 3, since two lips are inclined in the same direction, two lips need to be arranged with a certain amount of interval in between to prevent interfering with each other. Further, when a large lip is provided as a measure against the variation in location of the contact surface, a larger space is necessary to arrange two lips. As a result, the grommet will be large and production cost rises. Further, since the contact surface which the lip contacts needs to be made large, the degree of freedom of a layout decreases.

The object of the present invention is to provide a seal structure in which deterioration in sealability can be restrained even when the location of the contact surface varies, and downsizing of parts and improving of the degree of freedom of a layout can be provided.

### Solution to Problem

A seal structure disclosed herein includes a first panel, a second panel, and a grommet body. The first panel includes an aperture and a contact surface formed in the periphery of the aperture. The second panel is arranged on a side of the contact surface of the first panel. The grommet body includes a securing part, a main body part, an exterior edge part, a first seal, and a second seal. The securing part is secured to the second panel. The main body part, in which a penetration hole for inserting a cable therein is formed, is inserted in the aperture. The exterior edge part is arranged in the periphery of the main body part and faces the contact surface. The first seal is made of an elastic member. The first seal extends from the exterior edge part toward the contact surface so as to surround the main body part and to contact the contact surface. The second seal is made of an elastic member. The second seal extends from the exterior edge part toward the contact surface so as to surround the first seal and to contact the contact surface. An interval between the tip of the first seal and the tip of the second seal is configured to be wider than an interval between the proximal end of the first seal and the proximal end of the second seal.

In the seal structure, since the first seal includes an elastic member. The first seal extends from the exterior edge part toward the contact surface so as to surround the main body part, and the second seal includes an elastic member. The second seal extends from the exterior edge part toward the contact surface so as to surround the first seal, the first and second seals flexibly deform corresponding to the distance between the exterior edge part and the contact surface. In this manner, a measure is taken against the variation in location of the contact surface, thereby restraining deterioration in sealability.

Further, in the seal structure, when the first seal and the second seal are in contact with the contact surface, the interval between the tip of the first seal and the tip of the second seal is configured to be wider than the interval between the proximal end of the first seal and the proximal end of the second seal, so that interference between the first and second seals is prevented. In this manner, the first and second seals can be arranged close to each other, and thereby, the exterior edge part can be made small. As a result, the grommet body can be downsized. Further, since the contact surface can be made small, the degree of freedom of a layout improves.

### Advantageous Effects of Invention

As described above, according to the seal structure, deterioration in sealability can be restrained even when the location of the contact surface varies, and downsizing of a part and improving of the degree of freedom of a layout can be provided.

### BRIEF DESCRIPTION OF DRAWINGS

FIG. 1 is an exploded perspective view of a seal structure.

FIG. 2(A) is a perspective view of a panel unit.

FIG. 2(B) is a cross sectional view taken along the line IIB-IIB in FIG. 2(A).

FIG. 3 is a side view of a grommet body.

FIG. 4(A) is a side view of a grommet.

FIG. 4(B) is a view from the arrow IVB-IVB in FIG. 4(A).

FIG. 5(A) is a view from the arrow VA-VA in FIG. 4(A).

FIG. 5(B) is a cross sectional view taken along the line VB-VB in FIG. 5(A).

FIG. 6 is a partially enlarged view in FIG. 5(B).

FIG. 7 is a plan view of a retainer.

FIG. 8(A) is a plan view of the grommet body viewed from the retainer side.

FIG. 8(B) is a plan view of the grommet body viewed from the grommet side.

FIG. 9(A) is a perspective view of the seal structure.

FIG. 9(B) is a cross sectional view taken along the line IX-IX in FIG. 9(A).

FIG. 9(C) is a cross sectional view taken along the line IX-IX in FIG. 9(A).

FIG. 9(D) is a cross sectional view taken along the line IX-IX in FIG. 9(A).

FIG. 10 is a cross sectional view, in which the grommet body is attached to the panel unit, corresponding to FIG. 6.

### DESCRIPTION OF EMBODIMENTS

### 1. Overall Configuration

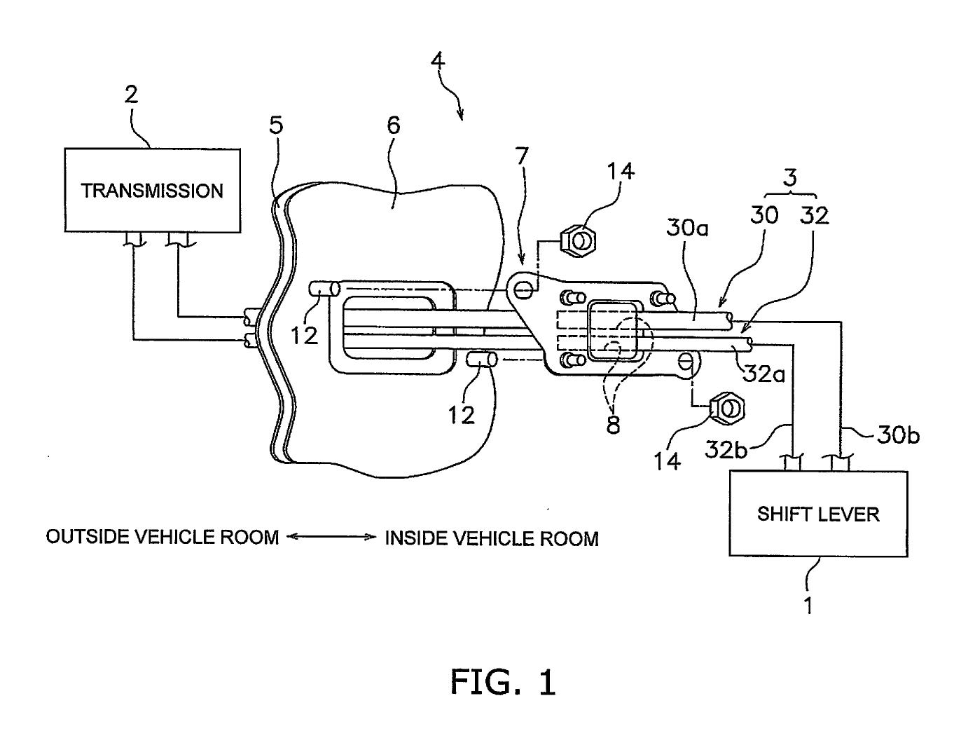

FIG. 1 is an exploded perspective view of a seal structure 4 according to the embodiment.

As illustrated in FIG. 1, a shift lever 1 is arranged inside the vehicle room and a transmission 2 is arranged outside the room. The shift lever 1 and the transmission 2 are connected with a cable 3.

The cable 3 is a control cable which transmits an operation, input to the shift lever 1 by a driver, to the transmission 2. Specifically, the cable 3 includes a shift cable 30 and a select cable 32. The shift cable 30 transmits longitudinal movement of the shift lever 1 to the transmission 2. The select cable 32 transmits side movement of the shift lever 1 to the transmission 2.

The shift cable 30 includes a tubular outer casing 30a and an inner cable 30b inserted in the outer casing 30a. When the driver moves the shift lever 1 in the longitudinal direction, the inner cable 30b in the outer casing 30a is pulled in the direction toward the shift lever 1 or pushed in the direction toward the transmission 2. In this manner, the longitudinal direction operation, input to the shift lever 1 by the driver, is transmitted to the transmission 2.

Similarly, the select cable 32 includes a tubular outer casing 32a and an inner cable 32b inserted in the outer casing 32a. When the driver moves the shift lever 1 in the side direction, the inner cable 32b in the outer casing 32a is pulled in the direction toward the shift lever 1 or pushed in the direction toward the transmission 2. In this manner, the side direction operation, input to the shift lever 1 by the driver, is transmitted to the transmission 2.

Further, by a drive force input to the transmission 2 via the inner cable 30b and the inner cable 32b, gear shifting is performed in the transmission 2.

A seal structure 4 is formed at the location to which the cable 3 is introduced from the inside to the outside of the room. The seal structure 4 includes a first panel 5, a second panel 6, and a grommet body 7. A penetration hole 8 in which the cable 3 is inserted is formed in the seal structure 4.

### 2. Panel Unit

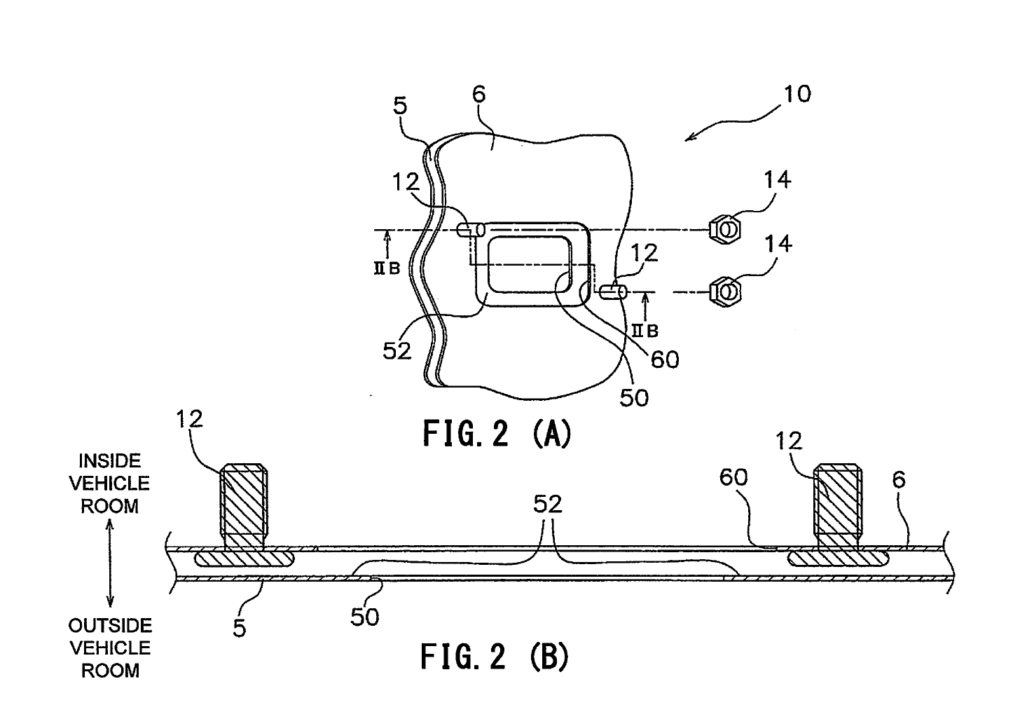

FIG. 2(A) is a perspective view of a panel unit 10, and FIG. 2(B) is a cross sectional view of the panel unit 10.

As illustrated in FIG. 2(A) and FIG. 2(B), the panel unit 10 includes the first panel 5, the second panel 6, a bolt 12, and a nut 14.

The first panel 5 is formed with an aperture 50, and has a contact surface 52 formed in the periphery of the aperture 50. In the embodiment, the first panel 5 is formed of steel.

The second panel 6 is arranged to face the contact surface 52 of the first panel 5. The second panel 6 is formed with an aperture 60. In the embodiment, the second panel 6 is formed of steel.

The second panel 6 is a frame constituting a base of the panel unit 10. The first panel 5 is a member supporting the second panel 6. The first panel 5 and the second panel 6 are secured to each other facing each other. Further, the first panel 5 and the second panel 6 are arranged with an interval in between. Further, the aperture 50 of the first panel 5 and the aperture 60 of the second panel 6 are arranged in each position to overlap each other. Since the size of the aperture 60 is greater than the size of the aperture 50, the contact surface 52 is exposed to the inside of the room through the aperture 60 when the grommet body 7 is not attached.

The bolt 12 is a member for securing the grommet body 7 to the panel unit 10. The bolt 12 is secured to the second panel 6 so as an external screw to protrude from the second panel 6 toward the inside of the room. In the embodiment, the bolt 12 is a weld bolt and arranged in two locations around the aperture 60.

The nut 14 is a member for securing the grommet body 7 to the panel unit 10. The nut 14 includes an internal screw, which engages with the external screw of the bolt 12, and can be attached to the bolt 12.

### 3. Grommet Body

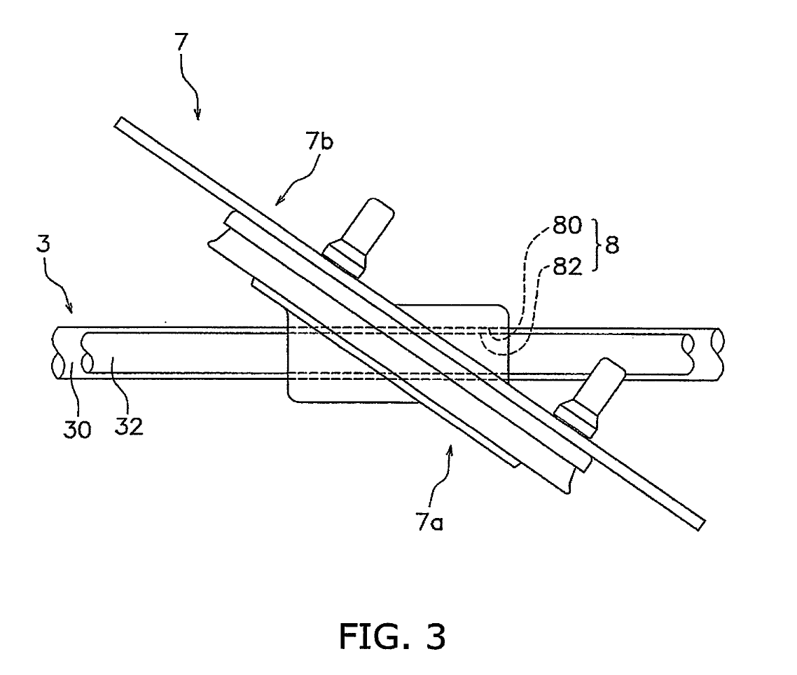

Now, the grommet body 7 will be described. As illustrated in FIG. 3 to FIG. 8, the grommet body 7 includes securing parts 73 and 75, a main body part 70, an exterior edge part 72, a first seal 74, and a second seal 76. The grommet body 7 will be described below in more detail.

FIG. 3 is a side view of the grommet body 7. As illustrated in FIG. 3, the grommet body 7 includes a grommet 7a and a retainer 7b. Further, a penetration hole 8 formed in the grommet body 7 includes a first penetration hole 80 in which the shift cable 30 is inserted and a second penetration hole 82 in which the select cable 32 is inserted.

3.1 Grommet

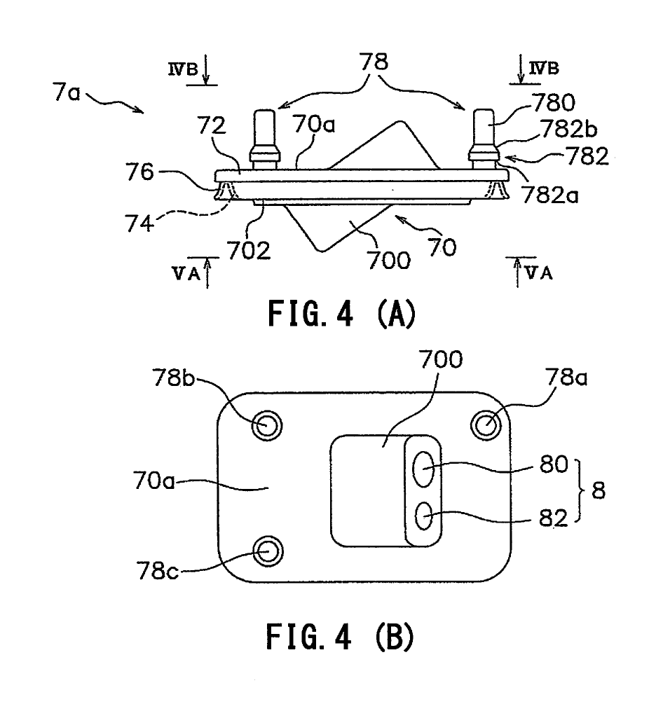

FIG. 4(A) is a side view of the grommet 7a, and FIG. 4(B) is a plan view of the grommet 7a viewed along the arrow IVB in FIG. 4(A).

The grommet 7a includes the main body part 70, the exterior edge part 72, the first seal 74, and the second seal 76. Further, the grommet 7a includes a receiving surface 70a formed by the main body part 70 and the exterior edge part 72. The grommet 7a is formed of an elastic material. In the embodiment, the grommet 7a is integrally formed of ethylene-propylene-diene rubber (EPDM). EPDM is an example of an elastic material. Details on the main body part 70, the exterior edge part 72, the first seal 74, and the second seal 76 will be described below. Note that, in FIG. 4(A), the first seal 74 is illustrated in a dashed line.

Connecting Part

The grommet 7a further includes a connecting part 78. The connecting part 78 is formed on at least either of the main body part 70 and the exterior edge part 72. In the embodiment, the connecting part 78 is formed on the exterior edge part 72 and includes a first connecting part 78a, a second connecting part 78b, and a third connecting part 78c, all having the same shape.

Each connecting part 78 includes a column shape part 780 and a stopper 782. The column shape part 780 protrudes from the receiving surface 70a in the direction approximately perpendicular to the receiving surface 70a. The stopper 782 is a portion protruding from the column shape part 780 in the radial direction and formed so as to surround the outer circumference of the column shape part 780. The stopper 782 includes a hooking surface 782a and a tapered surface 782b. The hooking surface 782a faces the receiving surface 70a. Between the hooking surface 782a and the receiving surface 70a, an interval of which dimension is approximately the same as the thickness of the retainer 7b is formed. The tapered surface 782b is formed in the opposite side to the hooking surface 782a of the stopper 782.

Main Body Part

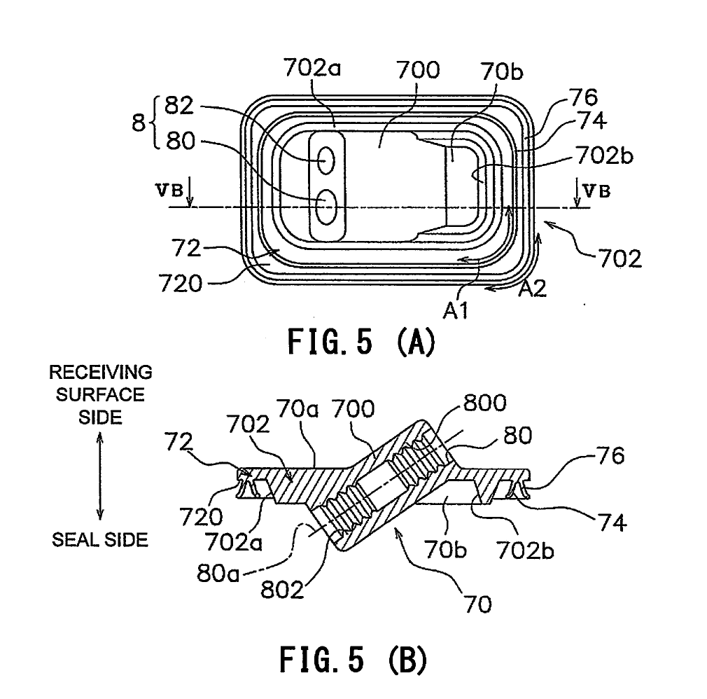

The main body part 70 will be described using FIG. 5(A) and FIG. 5(B). FIG. 5(A) is a plan view of the grommet 7a viewed along the arrow VA in FIG. 4(A), and FIG. 5(B) is a cross sectional view taken along the line VB-VB in FIG. 5(A).

In the main body part 70, the penetration hole 8 in which the cable 3 is inserted is formed. The main body part 70 is inserted in the aperture 50 and the aperture 60. The main body part 70 includes a cable supporting part 700 and a movement restricting part 702.

The cable supporting part 700 is a part for supporting the cable 3. On the cable supporting part 700, the penetration holes 8 (namely, the first penetration hole 80 and the second penetration hole 82) are formed. The penetration hole 8 communicates between the seal side of the grommet 7a in which the first seal 74 and the second seal 76 are arranged and the receiving surface 70a side.

The first penetration hole 80 extends along a center line 80a and includes a receiving surface side rib 800 and a seal side rib 802. Each of the receiving surface side rib 800 and the seal side rib 802 is formed on the inner wall of the first penetration hole 80 and has a plurality of annular protrusions lined in a direction parallel to the center line 80a. The receiving surface side rib 800 and the seal side rib 802 tightly makes contact with the outer circumferential surface of the shift cable 30 inserted in the penetration hole 80. In this manner, intrusion of an object and noise into the room from the outside of the room can be restrained via the first penetration hole 80. Further, the movement of the outer casing 30a is restrained in the first penetration hole 80, and the shift cable 30 is supported by the grommet 7a.

Since the second penetration hole 82 has a configuration similar to that of the first penetration hole 80, the detail on the second penetration hole 82 is omitted. The center line of the second penetration hole 82 is approximately parallel to the center line 80a of the first penetration hole 80.

The cable supporting part 700 extends along the direction parallel to the center line 80a. The center line 80a has an inclination against the direction perpendicular to the receiving surface 70a. In this manner, the cable supporting part 700 is inclined relative to the direction perpendicular to the receiving surface 70a so as to introduce the cable 3 into the inside of the room from the outside of the room along the panel unit 10.

The movement restricting part 702 is a part protruding toward the seal of the grommet 7a. The movement restricting part 702 is arranged in the periphery of the main body part 70, and includes an outer circumferential surface 702a and an inner circumferential surface 702b. When the grommet body 7 is attached to the panel unit 10, the movement restricting part 702 is inserted in the aperture 50 of the first panel 5. The outer circumferential surface 702a is connected to the seal surface 720 of the exterior edge part 72 and inclines toward the main body part 70. The inner circumferential surface 702b is formed between the outer circumferential surface 702a and the cable supporting part 700. A recessed portion 70b is formed between the inner circumferential surface 702b and the cable supporting part 700.

Exterior Edge Part

The exterior edge part 72 is arranged in the periphery of the main body part 70 and faces the contact surface 52. The exterior edge part 72 is a part, formed in a plate shape, protruding from the main body part 70 to form a flange portion. The exterior edge part 72 includes a seal surface 720 arranged on the seal side. The portion of the exterior edge part 72 opposite to the seal surface 720 constitutes a portion of the receiving surface 70a. The seal surface 720 is formed to be approximately parallel to the receiving surface 70a.

First Seal and Second Seal

The first seal 74 is a part formed to surround the main body part 70 with an elastic material. The first seal 74 is a sleeve-shaped part extending from the exterior edge part 72. The main body part 70 is arranged on the inner side of the first seal 74.

The second seal 76 is a part formed to surround the first seal 74 with an elastic member. The second seal 76 is a sleeve-shaped part extending from the exterior edge part 72. The first seal 74 and the main body part 70 are arranged in the inner side of the second seal 76.

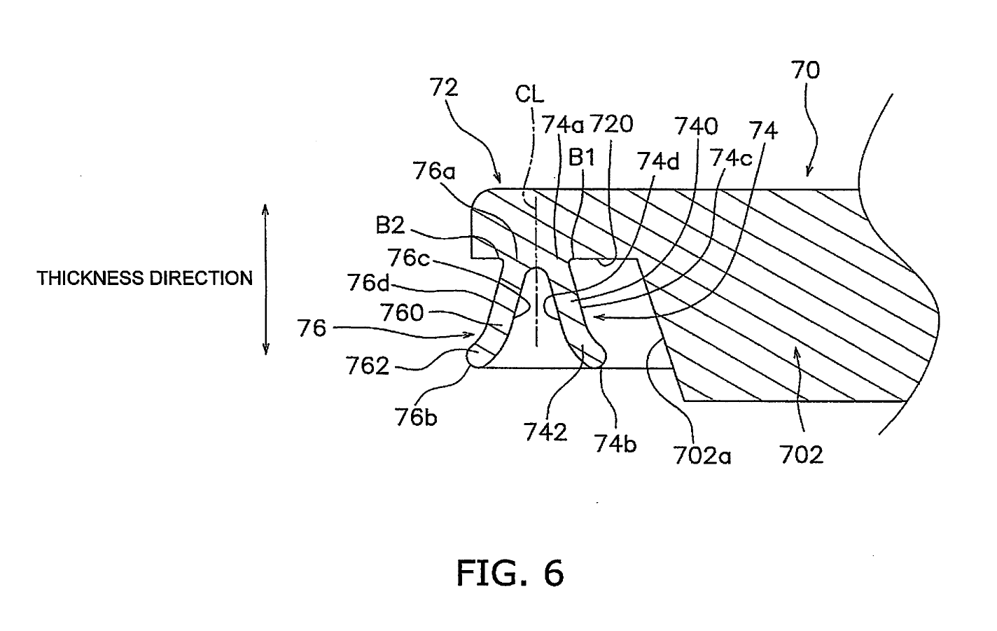

Using FIG. 6, the first seal 74 and the second seal 76 will be described. FIG. 6 is a figure in which the portion around the first seal 74 and the second seal 76 in FIG. 5(B) is enlarged. FIG. 6 illustrates an example of a cross section perpendicular to the circumferential direction A1 or the circumferential direction A2 which will be described below.

As illustrated in FIG. 6, the first seal 74 and the second seal 76 are formed so that the interval gradually increases toward tip portions 742 and 762 in a state-before the grommet body 7 is attached to the first panel 5 and the second panel 6. Further, the tip portion 742 of the first seal 74 and the tip portion 762 of the second seal 76 warp in directions parting from each other.

The first seal 74 includes a proximal end 74a, a tip 74b, the first tapered part 740, and the tip portion 742. Further, the first seal 74 includes a first inner wall surface 74c formed by the first tapered part 740 and the tip portion 742, and a first outer wall surface 74d.

The first seal 74 is connected to the exterior edge part 72 at the proximal end 74a. To describe in more detail, the first inner wall surface 74c of the first seal 74 is connected to the seal surface 720 of the exterior edge part 72. The boundary B1 between the first inner wall surface 74c and the seal surface 720 forms a closed curve surrounding the main body part 70. The circumferential direction A1 (see FIG. 5(A)) is determined as a direction parallel to the curve. The tip 74b is an end located in the opposite side to the proximal end 74a of the first seal 74. Further, in a view facing the seal surface 720, the tip 74b is arranged in the main body part 70 side further than the proximal end 74a.

The first tapered part 740 is a sleeve-shaped part extending from the exterior edge part 72 along the thickness direction perpendicular to the seal surface 720. Further, in a view facing the seal surface 720, the first tapered part 740 extends to the main body part 70 side further than the proximal end 74a.

The tip portion 742 is formed in the tip 74b side of the first seal 74. The tip portion 742 curves in an arc shape in a cross section perpendicular to the circumferential direction A1 of the first seal 74, and the inner side of the arc faces the inner side of the first seal 74. In other words, the tip portion 742 warps so as to part from the second seal 76.

The second seal 76 includes a proximal end 76a, a tip 76b, a second tapered part 760, and the tip portion 762. Further, the second seal 76 includes a second inner wall surface 76c formed with the second tapered part 760 and the tip portion 762, and a second outer wall surface 76d.

The second seal 76 is connected to the exterior edge part 72 at the proximal end 76a. To describe in more detail, the second outer wall surface 76d of the second seal 76 is connected to the seal surface 720 of the exterior edge part 72. The boundary B2 between the second outer wall surface 76d and the seal surface 720 forms a closed curve surrounding the main body part 70. The circumferential direction A2 (see FIG. 5(A)) is determined as a direction parallel to the curve. The tip 76b is an end located in the opposite side to the proximal end 74a of the first seal 74. Further, in a view facing the seal surface 720, the tip 76b is arranged on a side opposite to the main body part 70 with regard to the proximal end 76a.

The second tapered part 760 is a sleeve-shaped part extending from the exterior edge part 72 along the thickness direction perpendicular to the seal surface 720. Further, in a view facing the seal surface 720, the second tapered part 760 extends to the side opposite to the main body part 70 with regard to the proximal end 76a.

The tip portion 762 is formed in the side opposite to the proximal end 76a of the second seal 76. The tip portion 762 curves in an arc shape in a cross section perpendicular to the circumferential direction A2 of the second seal 76, and the inner side of the arc faces the outer side of the second seal 76. In other words, the tip portion 762 warps so as to part from the main body part 70 and the first seal 74.

The proximal end 74a of the first seal 74 and the proximal end 76a of the second seal 76 are provided to be close to each other. In the portion, the first outer wall surface 74d of the first seal 74 and the second inner wall surface 76c of the second seal 76 are continuous surfaces forming a V-shaped groove between two surfaces.

Further, the first seal 74 and the second seal 76 have a predetermined relationship with reference to an intermediate curved line CL, which passes between the proximal end 74a of the first seal 74 and the proximal end 76a of the second seal 76, and is perpendicular to the seal surface 720. Specifically, in a cross section perpendicular to the circumferential direction A1 or A2, the first seal 74 is arranged on the main body part 70 side with regard to the intermediate curved line CL, and the second seal 76 is arranged on the side opposite to the main body part 70 with regard to the intermediate curved line CL. Further, the first seal 74 and the second seal 76 are formed so as to gradually part from the intermediate curved line CL toward the tip portion 742 and the tip portion 762, respectively. That is, the distance between the first seal 74 and the second seal 76 gradually becomes greater toward the tip portion 742 and the tip portion 762.

3.2 Retainer

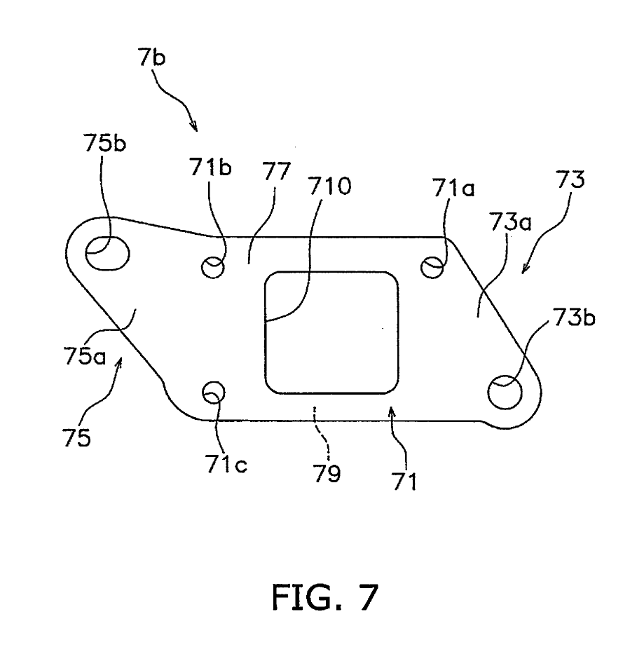

FIG. 7 is a plan view of the retainer 7b. The grommet body 7 includes the retainer 7b, which is connected to the connecting part 78 formed on the exterior edge part 72 of the grommet 7. The securing parts 73 and 75 are formed on the retainer 7b. Note that, the connecting part 78 may be formed at least on either of the main body part 70 and the exterior edge part 72.

The retainer 7b is a plate like member for securing the grommet 7a to the panel unit 10. The retainer 7b includes a pressing part 71 and securing parts 73 and 75. Further, the retainer 7b includes a room-side side surface 77 and a pressing surface 79 provided opposite to the room-side side surface 77, formed by the pressing part 71 and securing parts 73 and 75. In the embodiment, the retainer 7b is formed of steel.

The pressing part 71 is a part to which the grommet 7a is connected. The pressing part 71 has a shape corresponding to the shape of the grommet 7a. The pressing part 71 is a near-rectangle part. The pressing part 71 is formed with an aperture 710, a first positioning hole 71a, a second positioning hole 71b, and a third positioning hole 71c. The aperture 710 is formed approximately in the middle of the pressing part 71. The aperture 710 is provided to insert the cable supporting part 700 of the grommet 7a therein. Three holes, that is, the first to third positioning holes 71a to 71c, have the same shape and are formed in the periphery of the aperture 710. The first to third positioning holes 71a to 71c are provided to insert the first to third connecting parts 78a to 78c of the grommet 7a therein, respectively.

The securing parts 73 and 75 are secured to the second panel 6. The securing part 73 includes a wing part 73a extending from the pressing part 71 and a hole 73b formed on the wing part 73a. Further, the securing part 75 includes a wing part 75a extending from the pressing part 71 and a hole 75b formed on the wing part 75a. The width of the portion of the securing parts 73 and 75 becomes narrower for the portion farer from the pressing part 71 and closer to the end portion. Holes 73b and 75b are formed on each end portion of the securing parts 73 and 75. The holes 73b and 75b are provided to insert therein the bolt 12 of the panel unit 10. The hole 75b has a shape formed by extending a circle in a certain direction, instead of a circle, so as to allow a play.

### 4. Seal Structure Forming

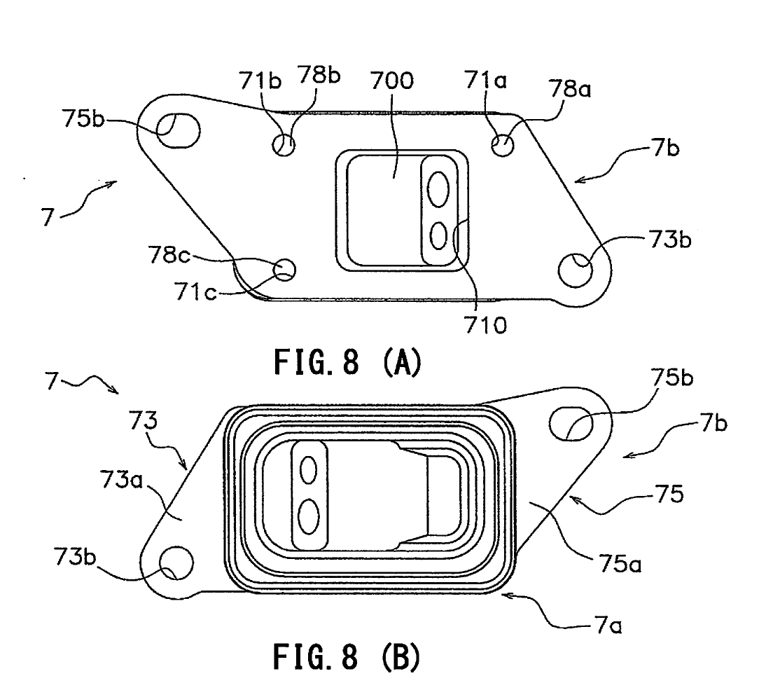

FIG. 8(A) is a plan view of a grommet body 7 viewed from the retainer 7b side, and FIG. 8(B) is a plan view of the grommet body 7 viewed from the grommet 7a side.

The grommet body 7 is assembled to form the seal structure 4. The grommet 7a and the retainer 7b are connected via the connecting part 78 to assemble the grommet body 7. Specifically, the first to third connecting parts 78a to 78c of the grommet 7a are inserted in the positioning holes of the retainer 7b. Each of the first to third positioning holes 71a to 71c engages in an interval between the hooking surface 782a of the stopper 782 of each of the first to third connecting parts 78a to 78c, respectively, and the receiving surface 70a. Diameters of first to third positioning holes 71a to 71c are provided to be smaller than the diameter of the stopper 782, though the stopper 782 can pass the first to third positioning holes 71a to 71c by deforming since the stopper is formed of an elastic material. In this step, the formed tapered surface 782b allows the first to third positioning holes 71a to 71c to further smoothly engage in the connecting part 78. Further, since the movement of the retainer 7b is restricted by the hooking surface 782a, the grommet 7a is not likely to come off from the retainer 7b.

When the retainer 7b is attached to the grommet 7a, the receiving surface 70a of the grommet 7a abuts against the pressing surface 79 of the retainer 7b. Further, the cable supporting part 700 of the grommet 7a is inserted in the aperture 710 of the retainer 7b.

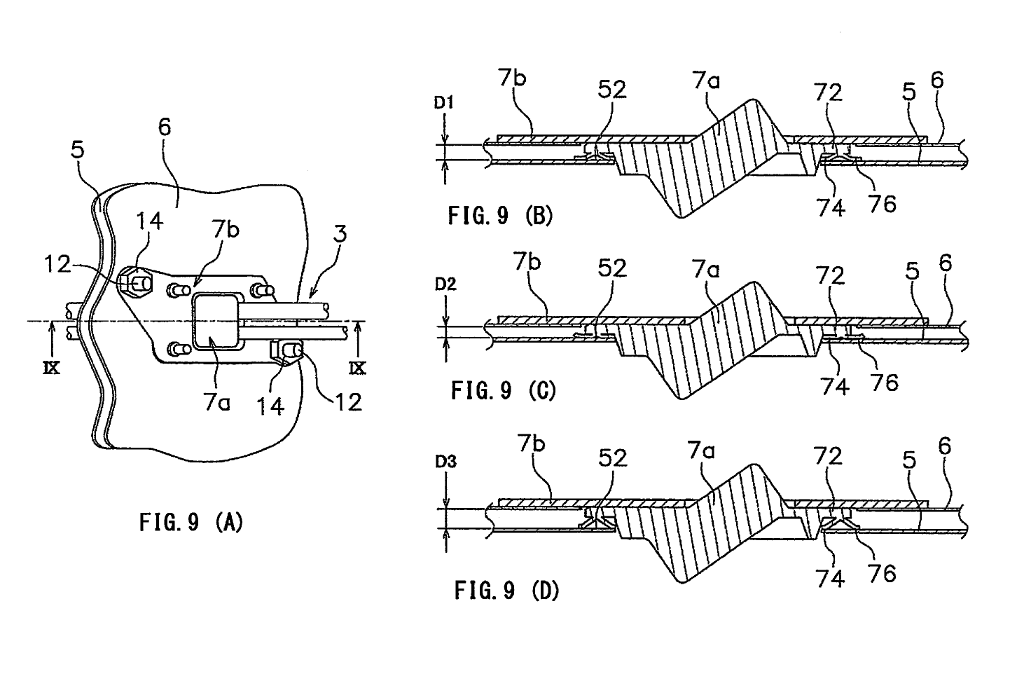

Next, the grommet body 7 is attached to the panel unit 10 to form the seal structure 4. FIG. 9(A) is a perspective view illustrating the external of the seal structure 4.

The cable 3 is inserted in the penetration hole 8 of the grommet body 7. The cable 3 is further inserted in the aperture 50 of the first panel 5 and the aperture 60 of the second panel 6. Then the grommet body 7 is secured on the panel unit 10. Specifically, the bolt 12 is inserted in the holes 73b and 75b of the retainer 7b and the nut 14 is screwed on the bolt 12. That is, the securing parts 73 and 75 are secured on the second panel 6. In this step, the main body part 70 of the grommet 7a is inserted in the aperture 50 of the first panel 5. Then, pressure is applied to the receiving surface 70a of the grommet 7a from the pressing surface 79 of the retainer 7b so that the first seal 74 and the second seal 76 are pressed to the contact surface 52 of the first panel 5.

As described above, the seal structure 4 is formed. The seal structure 4 restrains intrusion of an object such as water and dust through the aperture 50.

### 5. Arrangement of Component of Seal Structure

Panel Unit Arrangement

FIG. 9(B) to FIG. 9(D) are cross sectional views taken along the line IX-IX in FIG. 9(A). In FIG. 9(B) to FIG. 9(D), the first panel 5 and the second panel 6 are parted by a distance D1, a distance D2, and a distance D3, respectively, where distance D2<distance D1<distance D3. In manufacturing of the panel unit 10, the distance between the first panel 5 and the second panel 6 may vary when the first panel 5 and the second panel 6 are secured to each other. The distances D1 to D3 are an example of the distance between the first panel 5 and the second panel 6 in the panel unit 10. In the embodiment, the distance D1 is a design value. A tolerance range is determined for the distance between panels with variation considered. The values of distances D2 and D3 are within the tolerance range.

When the grommet body 7 is secured to the second panel 6, the grommet body 7 is positioned relative to the first panel 5. Heights of the first seal 74 and the second seal 76 are determined so as to accommodate a case when the distance between panels is at the maximum value of the tolerance range. That is, heights of the first seal 74 and the second seal 76 are determined so as that the first seal 74 and the second seal 76 make contact with the contact surface 52 of the first panel 5 with a certain degree of pressure sufficient for providing sealability. In this manner, as illustrated in FIG. 9(D), even when two panels are parted by the distance D3 which is greater than the distance D1, that is, the design value of the distance between panels, seal is formed without deteriorating sealability.

Note that, the height of the first seal 74 is the dimension of the first seal 74 in the direction perpendicular to the seal surface 720 (or thickness direction) when the seal surface 720 of the exterior edge part 72 is taken as a reference. The height of the second seal 76 is determined in the similar manner. In the embodiment, the height of the first seal 74 is approximately the same as the height of the second seal 76.

Further, when the first seal 74 and the second seal 76 are pressed against the first panel 5, the first seal 74 and the second seal 76 are extended toward directions opposite to each other. Therefore, even when two panels are parted by the distance D2 which is smaller than the distance D1, that is, the design value of the distance between panels, interference between the first seal 74 and the second seal 76 does not occur.

Structure Around First and Second Seals

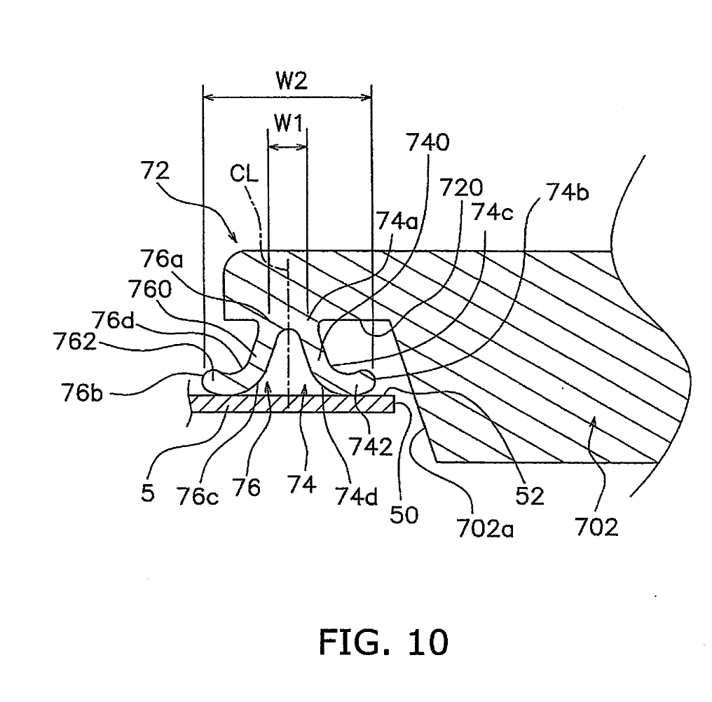

Arrangement of each component of the seal structure 4 will further be described using FIG. 10. FIG. 10 illustrates a cross section around the first seal 74 and the second seal 76 of the seal structure 4.

The first seal 74 extends from the exterior edge part 72 toward the contact surface 52 so as to surround the main body part 70 with an elastic material and to contact the contact surface 52. The second seal 76 extends from the exterior edge part 72 toward the contact surface 52 so as to surround the first seal 74 with an elastic member and to contact the contact surface 52. The interval W2 between the tip 74b of the first seal 74 and the tip 76b of the second seal 76 is wider than the interval W1 between the proximal end 74a of the first seal 74 and the proximal end 76a of the second seal 76.

The grommet body 7 is secured to the second panel 6, and the exterior edge part 72 faces the contact surface 52 when the seal structure 4 is formed. To describe in more detail, the seal surface 720 and the contact surface 52 face each other. Further, the seal surface 720 is arranged approximately parallel to the contact surface 52.

Further, the movement restricting part 702 is inserted in the aperture 50 of the first panel 5, with the outer circumferential surface 702a being arranged in a location in the vicinity of, or adjacent to, the aperture 50. That is, even when a force is applied to the grommet 7a via the cable 3, the movement of the grommet 7a is restricted by the outer circumferential surface 702a and the aperture 50 making contact with each other.

As described above, the first seal 74 and the second seal 76 are formed so that the interval gradually increases toward the tip portions 742 and 762 in a state before the grommet body 7 is attached to the first panel 5 and the second panel 6. Further, the tip portion 742 and the tip portion 762 warp in directions parting from each other. By this configuration, when the grommet body 7 is attached to the first panel 5 and the second panel 6, the first outer wall surface 74d of the first seal 74 and the second inner wall surface 76c of the second seal 76 contact the contact surface 52. Further, the first tapered part 740 and the second tapered part 760 deflect so that the interval between the tip 74b and the tip 76b is pushed to be widened. When the seal structure 4 is formed, the first outer wall surface 74d of the first seal 74 and the second inner wall surface 76c of the second seal 76 are pressed against the contact surface 52, making tight contact.

Even when the seal structure 4 is formed, the first seal 74 and the second seal 76 have a relationship similar to that of a state before the grommet body 7 is attached to the first panel 5 and the second panel 6. That is, in a view facing the contact surface 52, the tip 74b of the first seal 74 is arranged on the main body part 70 side further than the proximal end 74a, and the tip 76b of the second seal 76 is arranged on the side opposite to the main body part 70 with regard to the proximal end 76a. Further, in a view facing the contact surface 52, the first seal 74 extends toward the main body part 70 further than the proximal end 74a, and the second seal 76 extends to the side opposite to the main body part 70 with regard to the proximal end 76a. Furthermore, in a cross section perpendicular to circumferential direction A1 or A2, the first seal 74 is arranged on the main body part 70 side with regard to the intermediate curved line CL, and the second seal 76 is arranged in the opposite side to the main body part 70 with regard to the intermediate curved line CL. Further, the first seal 74 and the second seal 76 part from the intermediate curved line CL toward the tip portion 742 and the tip portion 762, respectively.

### 6. Effect of Embodiment

Now, the effect of the seal structure 4 will be described.

(1)

In the seal structure 4, since the first seal 74 extends from the exterior edge part 72 toward the contact surface 52 so as to surround the main body part 70 with an elastic member, and the second seal 76 extends from the exterior edge part 72 toward the contact surface 52 so as to surround the first seal 74 with an elastic member, the first seal 74 and the second seal 76 flexibly deform corresponding to the distance between the exterior edge part 72 and the contact surface 52. In this manner, a measure is taken against the variation in location of the contact surface 52, thereby restraining deterioration in sealability.

Further, in the seal structure 4, since the interval W2 between the tip 74b of the first seal 74 and the tip 76b of the second seal 76 is provided to be wider than the interval W1 between the proximal end 74a of the first seal 74 and the proximal end 76a of the second seal 76, interference between the first seal 74 and the second seal 76 is prevented. Therefore, the first seal 74 and the second seal 76 can be arranged close to each other so that the exterior edge part 72 can be made small. As a result, the grommet body 7 can be downsized, and thereby cost can be reduced. Further, the contact surface 52 can be made small so that the degree of freedom of a layout is improved.

As described above, according to the seal structure 4, deterioration in sealability can be restrained even when the location of the contact surface 52 varies, and downsizing of a part and improving of the degree of freedom of a layout can be provided.

(2)

In the seal structure 4, the first seal 74 and the second seal 76 are formed so that the interval gradually increases toward the tip portions 742 and 762 in a state before the grommet body 7 is attached to the first panel 5 and the second panel 6.

Thereby, when the grommet body 7 is attached to the first panel 5 and the second panel 6, the first seal 74 and the second seal 76 deform so as that the interval between the tip portions 742 and 762 becomes wider than before the grommet body 7 is attached. Therefore, interference between the first seal 74 and the second seal 76 can surely be prevented.

(3)

In the seal structure 4, the tip portion 742 of the first seal 74 and the tip portion 762 of the second seal 76 warp in directions parting from each other.

Thereby, when the first seal 74 and the second seal 76 contact the contact surface 52, the tip portions 742 and 762 are further securely guided in directions parting from each other. Therefore, interference between the first seal 74 and the second seal 76 can further securely be prevented.

(4)

In the seal structure 4, the grommet body 7 includes the retainer 7b, which is connected to the connecting part 78 formed on the exterior edge part 72. The securing parts 73 and 75 are formed on the retainer.

As described above, since the securing parts 73 and 75 are formed on the retainer 7b which is an independent member, the grommet body 7 can be secured to the second panel 6 and at the same time, the first seal 74 and the second seal 76 can be pressed against the first panel 5. Further, since the retainer 7b is provided as an independent member, the retainer 7b can be formed of a material different from an elastic material forming the first seal 74 and the second seal 76. Thereby, the grommet body 7 can be strengthened and protected.

(5)

In the seal structure 4, the exterior edge part 72 is pushed toward the second seal 76 by the elastic force produced by the first seal 74 and also pushed toward the first seal 74 by the elastic force produced by the second seal 76. In this manner, the first seal 74 and the second seal 76 push each other, and thereby, forces acting on the exterior edge part 72 from the first seal 74 and the second seal 76, along the direction parallel to the contact surface 52, cancel each other. Therefore, it is easier to apply the force, between the exterior edge part 72 and the contact surface 52, acting along the direction perpendicular to the contact surface 52, than a case in which the first seal 74 and the second seal 76 are inclined in the same direction. As a result, even when a high pressure is applied to the exterior edge part 72 due to the variation in location of the contact surface 52, deflection of the exterior edge part 72 can be restrained.

The reason why such effect is obtained will specifically be described comparing with the prior art. As illustrated in FIG. 9(C), due to the variation in the distance between the first panel 5 and the second panel 6, the grommet body 7 may be secured to the second panel 6, strongly pressed against the contact surface 52. In this case, when a grommet, for example, as described in Patent Literature 3, is used as prior art, sealability of the seal formed between the grommet and the panel unit may be deteriorated.

In the grommet described in Patent Literature 3, when the grommet is pressed to the first panel 5, the lip is compressed between the contact surface 52 and the base plate of the grommet main body, thereby pushing the base plate by the elastic force produced by the compressed lip. In this state, since the lip obliquely extends from the base plate, the increase in the force of the lip pushing the base plate may cause deflection in the base plate. When the base plate deflects, an interval between the contact surface 52 and the grommet is likely to occur, thereby deteriorating sealability. Further, since the two lips extend in the same direction, the force of each lip pushing the base plate is combined so that the force of the lip pushing the base plate is greater than the case of a single lip. Therefore, the deflection in the base plate is likely to occur.

However, in the seal structure 4 according to the embodiment, even when a high pressure is applied to the exterior edge part 72 due to the variation in location of the contact surface 52, deflection of the exterior edge part 72 can be restrained, so that the first seal 74 and the second seal 76 can be provided, with the deterioration in sealability being restrained.

### 7. Other Embodiment

As described above, an embodiment according to the present invention is described. However, the present invention is not limited to the embodiment, and various alterations can be made without departing from the spirit and the scope of the present invention. Particularly, a plurality of embodiments and exemplary modifications described in the specification can optionally be combined as required.

(A)

In the embodiment described above, the grommet body 7 includes the grommet 7a and the retainer 7b, which are separate members. However, the grommet 7a and the retainer 7b are not necessarily separate members. For example, the grommet body 7 may be an integrated member provided with a function which the grommet 7a has and a function which the retainer 7b has. The grommet 7a may include a securing part which is secured on the second panel 6.

(B)

In the embodiment described above, the connecting part 78 is formed on the exterior edge part 72. However, the connecting part 78 may be formed on the main body part 70. Further, the connecting part 78 may be formed on the main body part 70 and the exterior edge part 72.

(C)

In the embodiment described above, the cable 3 is a control cable connecting the shift lever 1 and the transmission 2. However, the cable 3 may be a cable other than such control cable. For example, the cable 3 may be a control cable connecting a parking brake and an actuator which supplies a load for operating the parking brake.

(D)

In the embodiment described above, the first seal 74 is formed so that the interval gradually increases from the proximal end 74a toward the tip portion 742 and the second seal 76 is formed so that the interval gradually increases from the proximal end 76a toward the tip portion 762, in a state before the grommet body 7 is attached to the first panel 5 and the second panel 6. However, if the first seal 74 and the second seal 76 can be configured to deform so as to increase the interval at the tip portions 742 and 762 of the first seal 74 and the second seal 76 wider than before the grommet body 7 is attached to the first panel 5 and the second panel 6 and the first seal 74 and thereby the second seal 76 makes contact with the contact surface 52, it is not necessary to form the first seal 74 so that the interval gradually increases from the proximal end 74a toward the tip portion 742 and to form the second seal 76 so that the interval gradually increases from the proximal end 76a toward the tip portion 762, in a state before the grommet body 7 is attached to the first panel 5 and the second panel 6.

In the embodiment described above, the tip portion 742 of the first seal 74 and the tip portion 762 of the second seal 76 warp in directions parting from each other, in a state before the grommet body 7 is attached to the first panel 5 and the second panel 6. However, if the tip portions 742 and 762 can be guided in directions parting from each other when the grommet body 7 is attached to the first panel 5 and the second panel 6 and the first seal 74 and the second seal 76 makes contact with the contact surface 52, it is not necessary to configure the tip portion 742 of the first seal 74 and the tip portion 762 of the second seal 76 to warp in directions parting from each other, in a state before the grommet body 7 is attached to the first panel 5 and the second panel 6.

Further, in the embodiment described above, the first penetration hole 80 and the second penetration hole 82 in which the cable 3 is inserted are formed on the main body part 70, though the number of penetration holes is not limited to two. A single penetration hole may be formed, or three or more penetration holes may be formed.

### INDUSTRIAL APPLICABILITY

The art disclosed herein is advantageous in that the art can be used for a seal structure including a panel unit having two panels facing each other and a grommet, thereby restricting deterioration in sealability.

### REFERENCE SIGNS LIST

3 cable
4 seal structure
5 first panel
6 second panel
7 grommet body
7b retainer
8 penetration hole
50 aperture
52 contact surface
70 main body part
72 exterior edge part
73 securing part
74 first seal
74a proximal end
74b tip
75 securing part
76 second seal
76a proximal end
76b tip
78 connecting part
742 tip portion
762 tip portion

1. A seal structure comprising:
a first panel formed with an aperture and including a contact surface formed in a periphery of the aperture;
a second panel arranged on a side of the contact surface of the first panel;
a grommet body including
a securing part secured to the second panel,
a main body part, in which a penetration hole for inserting a cable therein is formed, the main body part being configured to be inserted in the aperture,
an exterior edge part arranged in a periphery of the main body part and facing the contact surface,
a first seal made of an elastic material, the first seal extending from the exterior edge part toward the contact surface so as to surround the main body part and to contact the contact surface, and
a second seal made of an elastic member, the second seal extending from the exterior edge part toward the contact surface so as to surround the first seal and to contact the contact surface,
and an interval between a tip of the first seal and a tip of the second seal being configured wider than an interval between a proximal end of the first seal and a proximal end of the second seal.

2. The seal structure according to claim 1, wherein the first seal and the second seal are formed so that the interval gradually increases toward tip portions, in a state before the grommet body is attached to the first panel and the second panel.

3. The seal structure according to claim 1, wherein a tip portion of the first seal and a tip portion of the second seal warp in directions parting from each other.

4. The seal structure according to claim 1, wherein the grommet body includes a retainer connected to a connecting part formed on at least either of the main body part and the exterior edge part, and the securing part is formed on the retainer.

5. The seal structure according to claim 2, wherein a tip portion of the first seal and a tip portion of the second seal warp in directions parting from each other.

6. The seal structure according to claim 5, wherein the grommet body includes a retainer connected to a connecting part formed on at least either of the main body part and the exterior edge part, and the securing part is formed on the retainer.

7. The seal structure according to claim 2, wherein the grommet body includes a retainer connected to a connecting part formed on at least either of the main body part and the exterior edge part, and the securing part is formed on the retainer.

8. The seal structure according to claim 3, wherein the grommet body includes a retainer connected to a connecting part formed on at least either of the main body part and the exterior edge part, and the securing part is formed on the retainer.
